(19) United States
(12) Patent Application Publication
(10) Pub. No.: US 2016/0196491 A1
(43) Pub. Date: Jul. 7, 2016

(54) Method For Recommending Content To Ingest As Corpora Based On Interaction History In Natural Language Question And Answering Systems

(71) Applicant: International Business Machines Corporation, Armonk, NY (US)

(72) Inventors: Swaminathan Chandrasekaran, Dallas, TX (US); Bharath Dandala, Austin, TX (US); Lakshminarayanan Krishnamurthy, Round Rock, TX (US); Alvin C. Richardson, Austin, TX (US)

(21) Appl. No.: 14/861,498

(22) Filed: Sep. 22, 2015

Related U.S. Application Data
(63) Continuation of application No. 14/588,685, filed on Jan. 2, 2015.

(51) Int. Cl. G06N 5/02; G06F 17/30; G06F 17/28

(52) U.S. Cl. CPC G06N 5/02; G06F 17/28; G06F 17/30554; G06F 17/30572

(57) ABSTRACT

An approach is provided for generating actionable content ingestion recommendations based on an interaction history that is mined to extract interaction context parameters from questions and answer results that meet specified answer deficiency criteria by searching one or more content sources using the extracted interaction context parameters to identify new content that is relevant to improving the first answer, and then presenting the new content in an actionable content ingestion recommendation list for display and review by a domain expert, where the actionable content ingestion recommendation list recommends the new content for ingestion in a knowledge base corpus.

### BACKGROUND OF THE INVENTION

In the field of artificially intelligent computer systems capable of answering questions posed in natural language, cognitive question answering (QA) systems (such as the IBM Watson™ artificially intelligent computer system or and other natural language question answering systems) process questions posed in natural language to determine answers and associated confidence scores based on knowledge acquired by the QA system. In operation, users submit one or more questions through a front-end application user interface (UI) or application programming interface (API) to the QA system where the questions are processed to generate answers that are returned to the user(s). The QA system generates multiple hypothesis in the form of answers from an ingested knowledge base (also known as the corpus) which can come from a variety of sources and formats, including HTML, PDF, and text documents, thereby formulating answers using a natural language process to provide answers with associated evidence and confidence measures. However, the quality of the answer depends on the information contained in the knowledge base corpus, so it is possible that not all responses will have high confidence measures, and some may not even have the right answers due to insufficient content or nonexistent content in the knowledge base corpus. With traditional QA systems, there is no mechanism in place to understand if the ingested corpus has the relevant content when the QA system responds with very low confidence answer or cannot find the right answers or if the corpus has enough depth/coverage on the topic the question was asked. Nor are traditional QA systems able to identify and ingest new content based on user interactions to provide a good overall experience except through use of a laborious manual processes whereby a domain expert reviews and selects documents for ingestion into a corpus. As a result, the existing solutions for efficiently identifying and ingesting content into a corpus are extremely difficult at a practical level.

### SUMMARY

Broadly speaking, selected embodiments of the present disclosure provide a system, method, and apparatus for processing of inquiries to an information handling system capable of answering questions by using the cognitive power of the information handling system to recommend content for ingestion into the knowledge base corpus based on user interactions and information extracted therefrom. In selected embodiments, the information handling system may be embodied as a question answering (QA) system which receives and answers one or more questions from one or more users. To answer a question, the QA system has access to structured, semi-structured, and/or unstructured content contained or stored in one or more large knowledge databases (a.k.a., “corpus”). To improve the quality of answers provided by the QA system, an ingestion content recommendation engine is periodically or manually triggered to process user interactions associated with low confidence or low quality answers to extract a plurality of variables and context information for use in performing multifactorial Latent Dirichlet Allocation (LDA) analysis to find the true intent for a low confidence/quality answer which is used to identify new content from heterogeneous content sources (e.g., document repositories, content management systems, cloud based repositories, etc.) which may be presented to a domain expert as a content ingestion recommendation for consideration, review, and selection. The variables and context information extracted from the interaction history for each low confidence/quality answer may include, but are not limited to, question terms or concepts, lexical answer type, n-grams, user context information (e.g., user ID, user group, user name, age, gender, date, time, location, originating device type, name, or IP address, agreed upon confidence service level agreement for the end user), answer terms or concepts, answer confidence measure, supporting evidence for the answer. The ingestion content recommendation engine uses the extracted variables and context information to mine the interaction history to identify low confidence/quality answers that meet specified answer deficiency criteria (e.g., low confidence, no answer, negative sentiment, repeated questions, absence of evidence, answers with a certain confidence threshold for a given class of users, etc.) to find and filter relevant content in one or more content sources (e.g., enterprise content management or knowledge management system repositories) that will improve the quality of the answer, and to recommend the resulting content for ingestion into the knowledge database corpus used by the QA system. The ingestion content recommendations may include, for each recommendation, a link to the recommended source document and reasons for making the recommendation. In this way, the domain expert or system knowledge expert can review and evaluate the ingestion content recommendations to select one or more recommended source documents for ingestion into the natural language-based QA system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that uses a knowledge base and an ingestion content recommendation engine for recommending content to ingest into the knowledge base;

FIG. 2 is a block diagram of a processor and components of an information handling system such as those shown in FIG. 1;

FIG. 3 illustrates a simplified flow chart showing the logic for generating content ingestion recommendations using extracted user profile data and historical interaction information to run multifactorial topical models on selected low quality questions to find relevant content recommendations.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

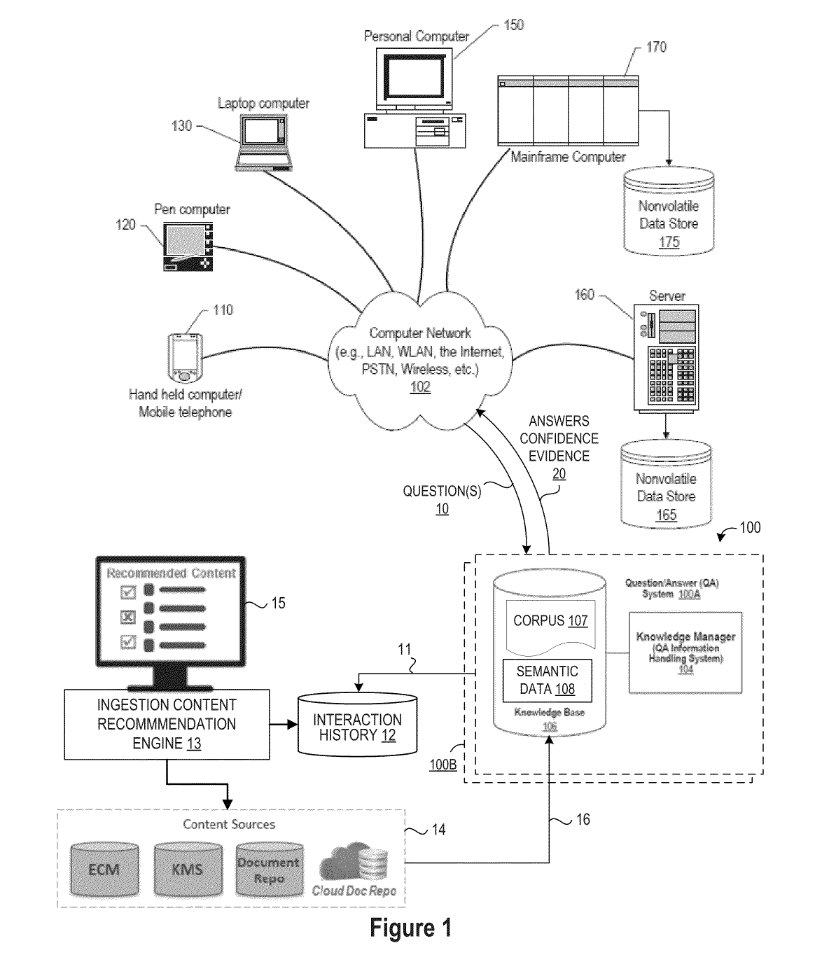

FIG. 1 depicts a schematic diagram of one illustrative embodiment of a question/answer (QA) system 100 connected to a computer network 102. The QA system 100 may include one or more QA system pipelines 100A, 100B, each of which includes a computing device 104 (comprising one or more processors and one or more memories, and potentially any other computing device elements generally known in the art including buses, storage devices, communication interfaces, and the like) for processing questions received over the network 102 from one or more users at computing devices (e.g., 110, 120, 130). Over the network 102, the computing devices communicate with each other and with other devices or components via one or more wired and/or wireless data communication links, where each communication link may comprise one or more of wires, routers, switches, transmitters, receivers, or the like. In this networked arrangement, the QA system 100 and network 102 may enable question/answer (QA) generation functionality for one or more content users. Other embodiments of QA system 100 may be used with components, systems, sub-systems, and/or devices other than those that are depicted herein.

In the QA system 100, the knowledge manager 104 may be configured to receive inputs from various sources. For example, knowledge manager 104 may receive input from the network 102, one or more knowledge bases or corpora of electronic documents 106 or other data, a content creator 108, content users, and other possible sources of input. In selected embodiments, the knowledge base 106 may include structured, semi-structured, and/or unstructured content in a plurality of documents that are contained in one or more large knowledge databases or corpora. The various computing devices (e.g., 110, 120, 130) on the network 102 may include access points for content creators and content users. Some of the computing devices may include devices for a database storing the corpus of data as the body of information used by the knowledge manager 104 to generate answers to cases. The network 102 may include local network connections and remote connections in various embodiments, such that knowledge manager 104 may operate in environments of any size, including local and global, e.g., the Internet. Additionally, knowledge manager 104 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in an electronic document for use as part of a corpora 107 of data with knowledge manager 104. The corpora 107 may include any structured and unstructured documents, including but not limited to any file, text, article, or source of data (e.g., scholarly articles, dictionary definitions, encyclopedia references, and the like) for use in knowledge manager 104. Content users may access knowledge manager 104 via a network connection or an Internet connection to the network 102, and may input questions to knowledge manager 104 that may be answered by the content in the corpus of data. As further described below, when a process evaluates a given section of a document for semantic content, the process can use a variety of conventions to query it from the knowledge manager. One convention is to send a well-formed question 10. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions 10 (e.g., natural language questions, etc.) to the knowledge manager 104. Knowledge manager 104 may interpret the question and provide a response to the content user containing one or more answers 20 to the question 10. In some embodiments, knowledge manager 104 may provide a response to users in a ranked list of answers 20.

In some illustrative embodiments. QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question 10 which it then parses to extract the major features of the question, that in turn are then used to formulate queries that are applied to the corpus of data stored in the knowledge base 106. Based on the application of the queries to the corpus of data, a set of hypotheses, or candidate answers to the input question, are generated by looking across the corpus of data for portions of the corpus of data that have some potential for containing a valuable response to the input question.

In particular, a received question 10 may be processed by the IBM Watson™ QA system 100 which performs deep analysis on the language of the input question 10 and the language used in each of the portions of the corpus of data found during the application of the queries, including the cluster relationship information 109, using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e., candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 100 then generates an output response or answer 20 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

In addition to providing answers to questions, QA system 100 is connected to a content recommendation system 30 which recommends content for ingestion into the knowledge base corpus 106 based on historical user question and answer interactions and information extracted therefrom. To provide meaningful recommendations, the knowledge manager 104 may be configured store the interaction history 11 of questions and answers in an interaction history database 12, alone or in combination with extracted user feedback, such as rating, comments, profile, timing, and location information relating to each submitted question. In selected embodiments, the stored interaction history 11 may include variables and context information extracted from the interaction history, such as question terms, user context information (e.g., user ID, user group, user name, age, gender, date, time, location, originating device type, name, or IP address), answer terms, answer confidence measure, supporting evidence for the answer. To improve the quality of answers provided by the QA system 100, the content recommendation system 30 may be embodied as an information handling system which executes an ingestion content recommendation engine 13 that is periodically or manually triggered to process user interactions from the interaction history 12 to extract a plurality of variables and context information for low confidence or low quality question and answer interactions. To this end, the ingestion content recommendation engine 13 may use an extraction process, such as a semantic analysis tool or automatic authorship profiling tool, to extract the structure and semantics from the question text, such as user profile, timing, location, emotional content, authorship profile, and/or message perception. For example, the ingestion content recommendation engine 13 may use natural language (NL) processing to analyze textual information in the question and retrieved information from the interaction history database 12 in order to extract or deduce question context information related thereto, such as end user location information, end user profile information, time of day, lexical answer type (LAT) information, focus, sentiment, synonyms, and/or other specified terms. In addition, the ingestion content recommendation engine 13 may use a Natural Language Processing (NLP) routine to identify specified entity information in the corpora, where “NLP” refers to the field of computer science, artificial intelligence, and linguistics concerned with the interactions between computers and human (natural) languages. In this context, NLP is related to the area of human-to-computer interaction and natural language understanding by computer systems that enable computer systems to derive meaning from human or natural language input. The results of the extraction process may be processed by the ingestion content recommendation engine 13 with a multifactorial topical model to discover topical relationships from the interaction history. To this end, the ingestion content recommendation engine 13 may use an NLP or machine learning process which applies a topical model, such as a Latent Dirichlet Allocation (LDA) or Latent Semantic Analysis (LSA) model, to the extracted information and user interactions. By applying NLP processing and topical model to the historical user interaction information, the ingestion content recommendation engine 13 associates or correlates identified topics with extracted user context information, and uses the identified topics to search for new content from content sources 14 (e.g., enterprise content management or knowledge management system repositories or document repositories in the cloud) that will improve the quality of the answer. The identified content may be further processed by the ingestion content recommendation engine 13 for presentation to a domain expert as a content recommendation 15 for consideration, review, and selection. The content recommendation 15 may include, for each recommendation, a link to the recommended source document and reasons for making the recommendation. In this way, the domain expert or system knowledge expert can review and evaluate the content recommendations 15 to select one or more recommended source documents for ingestion into the natural language-based QA system. To this end, the content recommendation system 30 crawls and fetches selected content from the content sources 14 to for ingestion 16 into the knowledge database corpus 106 used by the QA system 100.

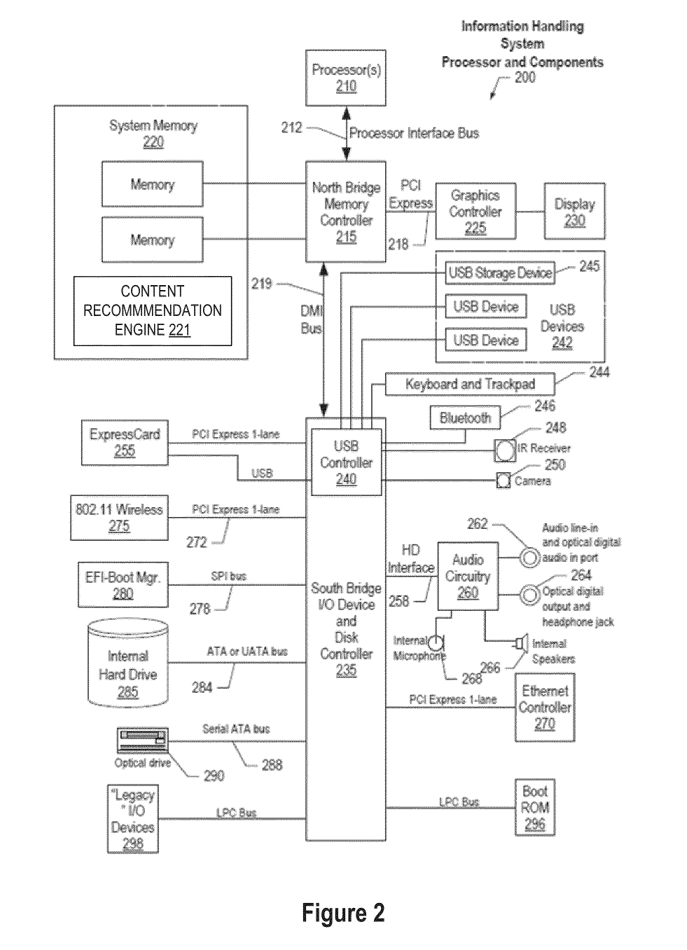

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server 160 utilizes nonvolatile data store 165, and mainframe computer 170 utilizes nonvolatile data store 175). The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. In the system memory 220, a variety of programs may be stored in one or more memory device, including a content recommendation engine module 221 which may be invoked to process user interactions to extract context information for use in performing multifactorial topical analysis to identify new content from content sources (e.g., document repositories) for presentation as a content ingestion recommendation for consideration, review, and selection. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” L/O devices (298) can include, for example, serial and parallel ports, keyboard, mouse, and/or a floppy disk controller. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards. ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etc.

Wireless Local Area Network (LAN) device 275 connects to Southbridge 235 via the PCI or PCI Express bus 272. LAN device 275 typically implements one of the IEEE 802.11 standards for over-the-air modulation techniques to wireless communicate between information handling system 200 and another computer system or device. Extensible Firmware Interface (EFI) manager 280 connects to Southbridge 235 via Serial Peripheral Interface (SPI) bus 278 and is used to interface between an operating system and platform firmware. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

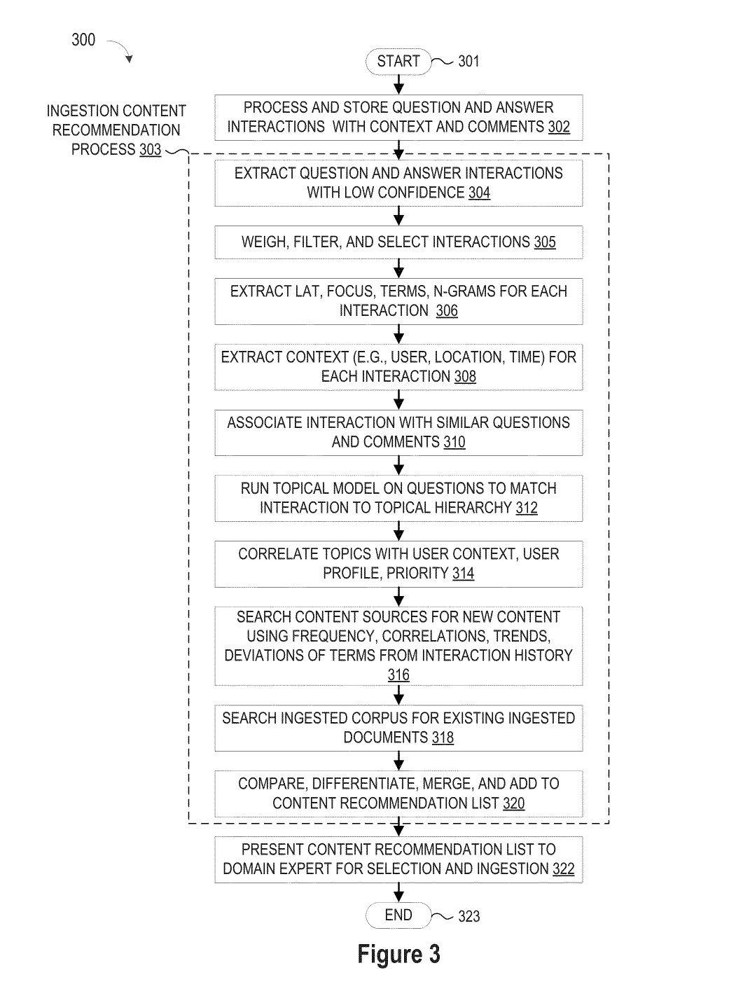

FIG. 3 depicts an approach that can be executed on an information handling system to generate content ingestion recommendations based on contextual information and historical interaction information extracted from questions presented to a knowledge management system, such as QA system 100 shown in FIG. 1, to run multifactorial topical models on selected low quality questions to find relevant content recommendations for ingestion in the knowledge base corpus 106. This approach can be included within the QA system 100 or provided as a separate ingestion content recommendation system, method, or module. Wherever implemented, the disclosed content recommendation scheme mines low confidence or low quality question and answers to extract a plurality of variables and context information, as well as unstructured and semi-structured documents and text from a plurality of content sources or document repositories. The mined information includes the presence of any key terms or phrases (e.g., smoke, suspicious bag, power outage, emergency, etc.) or named entities in the questions and answers which may be extracted by using NLP techniques. In addition, the mined user information may include user profile information for the end user(s), location information for the end user(s), and date or time information associated with each submitted question. Using the mined information, the ingestion content recommendation scheme uses NLP or machine learning processes to apply a topical model which uses the extracted information and user interactions to identify related topics and associated content from content sources (e.g., document repositories) which may be presented to a domain expert as a content ingestion recommendation for consideration, review, and selection. With the disclosed ingestion content recommendation scheme, an information handling system can be trained to generate and rank content recommendations for ingestion into the knowledge base corpus based on the context and profile of the user and extracted information from the question and answer interaction history.

To provide additional details for an improved understanding of selected embodiments of the present disclosure, reference is now made to FIG. 3 which depicts a simplified flow chart 300 showing the logic for generating content ingestion recommendations using extracted user profile data and historical interaction information to run multifactorial topical models on selected low quality questions to find relevant content recommendations. The processing shown in FIG. 3 may be performed by a cognitive system, such as the content recommendation system 30, QA system 100, or other natural language question answering system which recommendation for ingesting structured, semi-structured, and/or unstructured content into one or more knowledge databases.

FIG. 3 processing commences at 301 whereupon, at step 302, a question or inquiry from one or more end users is processed to generate an answer with associated evidence and confidence measures for the end user(s), and the resulting question and answer interactions are stored in an interaction history database (e.g., 12). The processing at step 302 may be performed at the QA system 100 or other NLP question answering system. As described herein, a Natural Language Processing (NLP) routine may be used to process the received questions and/or generate a computed answer with associated evidence and confidence measures, where “NLP” refers to the field of computer science, artificial intelligence, and linguistics concerned with the interactions between computers and human (natural) languages. In this context. NLP is related to the area of human-computer interaction and natural language understanding by computer systems that enable computer systems to derive meaning from human or natural language input.

In addition to processing questions to generate answers, the processing at step 302 may also include the extraction of context and comment information relating to the question and answer interaction. The context extraction processing at step 302 may be performed at the QA system 100 by an extraction process which uses a multimodal user interface (UI) or application programming interface (API) to process multimodal input questions 10 to effectively transform the different inputs to a shared or common format for context extraction processing on the received questions and/or on any computed answer. At this input stage, the extraction processing at step 302 may be suitably configured to understand or determine profile, location (which can be detected using the GPS on their mobile devices or approximation using IP address), date and time information for each of the end users, type of device used to submit a question, and the interests at the level of event the user is experiencing in a near real-time, thereby generating user context information for each question. For example, the processing at step 302 may apply a semantic analysis tool or automatic authorship profiling tool to obtain user profile information for the end user submitting each question. In selected example embodiments, the extraction processing at step 302 may generate user context information by leveraging location information of each end user, such as by detecting specific end user location information (e.g., GPS coordinates) based on the end user device capabilities, and/or by detecting approximation-based end user location information (e.g., origination IP address). In other embodiments, the context extraction processing step 302 may identify additional contextual information for each submitted question, such as key terms, focus, lexical answer type (LAT) information, sentiment, synonyms, and/or other specified terms. In addition to extracting context information, the processing at step 302 may capture and store any comments, sentiments, or other feedback provided by an end user in response to the computed answer.

While the QA system 100 or other NLP question answering system processes received questions and provides the set of responses or answers, the question and answer interaction may be logged and stored in an interaction history database (e.g. 12) along with extracted context attributes and associated comments regarding the quality or usefulness of the generated answer. In selected example embodiments, the stored interaction history database will log and persist predetermined user interaction data, such as question terms, user profile information (e.g., user ID, user group, user name, age, gender, date, time, location, originating device type, name, or IP address), answer terms, answer confidence measure, and supporting evidence for the answer.

To provide the QA system 100 or other NLP question answering system with a set of recommendations in terms of new content to ingest, an ingestion content recommendation process 303 is activated periodically or on demand to mine the interaction history and offer actionable insights by recommending new content to ingest in the knowledge database corpus. Once triggered, the ingestion content recommendation process 303 begins execution against the predetermined user interaction data stored in the interaction history database by first extracting or identifying the low confidence question and answer interactions at step 304. The processing at step 304 may be performed at the ingestion content recommendation engine 13 or the QA system 100 by identifying question and answer interactions where the confidence measure for the answer is below a minimum threshold. In addition or in the alternative, the extraction processing at step 304 may identify question and answer interactions where user feedback comments or captured sentiments indicate that the answer was not useful, or may identify question and answer interactions for questions that have been repeatedly asked. As will be appreciated, any desired user interaction data may be used to extract or identify low confidence question and answer interactions at step 304. For example, the capture device type data may indicate that the question was posed by a low bandwidth device or application (e.g., chat or mobile communication) which may limit the quality of the question.

At step 305, the selected low confidence interactions may be weighed and filtered based on selected user interaction data. The processing at step 305 may be performed at the ingestion content recommendation engine 13 or the QA system 100 by assigning weighting values to each interaction by employing a machine learning model that is configured to use selected user interaction data to identify, score, and rank the low confidence interactions. As will be appreciated, any desired machine learning model may be used which is a mathematical or statistical model to identify and score or rank the low confidence interactions. The mathematical model may include weighting values for each interaction being scored or ranked, and given a particular input of low confidence interactions, the interactions are input to the model and the model produces the score to indicate the relevance of the interactions. The individual interactions are variables to the model equation (a function with different weights for each interaction) and the application of the model to an interaction is given to produce a weighted value. Using the weighted values, the low confidence interactions may be filtered by removing any interaction having a weighted value that does not exceed a minimum threshold. The resulting interactions having weighted values above the minimum threshold are deemed qualified for a new content search, and thereby selected for further processing at step 305. Through the weighing and filtering process step 305, the ingestion content recommendation process 303 identifies interactions that should not generate new content searches, such as, for example, out-of-domain questions.

At step 306, the stored question and answer interactions are processed to perform a deep analysis on the language of the input question/answer by identifying or extracting a deep understanding for the question(s)/answer(s) being processed. The processing at step 306 may be performed at the ingestion content recommendation engine 13 or the QA system 100 or other NLP question answering system which employs extraction algorithms or machine learning model processes to extract information relating to the specified terms, named entities, question sentiment, focus. LAT, N-grams (contiguous sequence of n items from a given sequence of text or speech) or other context related information from the selected interaction(s). As described herein, a Natural Language Processing (NLP) routine may be used to perform extraction processing on the received questions and/or on any computed answer, where “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input. As a result of the processing step 306, information for each submitted question is identified, such as key terms, named entities, focus, lexical answer type (LAT) information, N-grams, sentiment, synonyms, and/or other specified terms. At the processing step 306, key words or phrases are extracted from the question request and/or answer. In addition or in the alternative, the processing step 306 may perform answering type to determine a lexical answer type (LAT) associated with an input query. In addition or in the alternative, the processing step 306 may assess the question focus associated with an input query and/or responsive answer output. In addition or in the alternative, the processing step 306 may perform sentiment analysis (also known as opinion mining) using natural language processing, text analysis and computational linguistics to identify and extract subjective information associated with an input query and/or responsive answer output. Using the knowledge base or corpus, the processing step 306 may also identify synonyms for the extracted question or answer terms. In an example situation where an end user submits a question, “Do I need to go to the doctor for a dog bite?”, the processing step 306 would extract the terms “doctor” and “dog bite” as key entity or key word information. In addition, the processing step 306 would detect that the lexical answer type (LAT) would be the guidelines or recommendations when a dog bite occurs. The processing step 306 would identify that the sentiment (beyond polarity) expressed in the question is “panic.” In another example situation where an end user asks. “How do I know if a dog has rabies?”, the processing step 306 would extract the terms “dog” and “rabies” as key entity information. In addition, the processing step 306 would detect that the lexical answer type (LAT) would be the care when bitten by rabies infected dog. And based on detecting that the disease type is rabies, the processing step 306 would identify that the sentiment of the question is “caution” and “critical.”

At step 308, the stored question and answer interactions are processed to obtain or extract contextual information from the input question/answer about each end user submitting a question to identify or extract a user context for each question. The processing at step 308 may be performed at the ingestion content recommendation engine 13 or the QA system 100 or other NLP question answering system which employs extraction algorithms or machine learning model processes to extract context information relating to the user, such as user profile, location, time, or other context related information from the selected interaction(s). As described herein, the context extraction process at step 308 may apply a semantic analysis tool or automatic authorship profiling tool to obtain user profile information for the end user submitting each question. As a result of the processing step 308, user context information for each submitted question is identified, such as user profile, timing, location, or other authorship profile indicators. By extracting profile information for each end user interacting with the cognitive system, other end users and associated interactions can be identified as an augmented information source for generating ingestion content recommendations. In an example situation where an end user submits a question, “How do I pay my energy bill?”, the extraction processing step 308 would extract user context information relating to the location (e.g., Austin, Tex.) from where the end user submitted the question (which can be detected using the GPS on their mobile devices or approximation using IP address), date and time information for the question, and the type of device used to submit the question. In selected example embodiments, the extraction processing step 308 may use an authorship profiling tool to automatically identify an author profile for the end user, such as the end user's age, gender, language, education, country, agreeableness, conscience, personality type (e.g., extroverted, neurotic, introverted, openness), or the like to provide a profile information the each end user associated with each question. In addition, the authorship profiling tool may identify contextual information about the end user based on one or more behavioral authentication techniques, such as linguistic profiling, temporal profiling, and/or geographic profiling. In an example situation where an end user submits a question, “a mad dawg bit me man. what do I?”, the authorship profiling tool would be applied to confidently predict that user is a male in his early 20's without a college education and having an extrovert personality. In another example situation where an end user asks, “Oh my God! I just saw a dog biting that poor man. What should I do?”, the authorship profiling tool would be applied to confidently predict that user is a college educated female having a caring and open personality.

At step 310, each stored question in a selected interaction is processed to identify similar questions and comments from other end users, thereby associating the selected interaction with similar questions and comments from the interaction history database. The processing at step 310 may be performed at the ingestion content recommendation engine 13 or the QA system 100 or other NLP question answering system which may apply filtering or association techniques to associate the question for a selected interaction with other similar questions from other interactions. As described herein, the association process at step 310 may apply a collaborative filtering or social filtering tool that filters for information or patterns by collaborating among multiple agents, viewpoints, data sources, etc., to make automatic associations (filtering) between questions from different end users (collaborating). In other embodiments, the association process at step 310 may apply a market-based analysis tool to make automatic associations between questions from different end users to obtain user comments that are similar to the selected interaction. The association processing step 310 is operative to cluster or group the questions that are of similar nature and eventually shown to the domain expert in the final review stage along with the recommended content. By doing so, the domain expert can get an understanding of how many questions can be affected and/or positively influenced through the addition of new content that is recommended. As a result of the processing step 310, the associated questions from different users may be used to obtain user comments that are similar to the selected interaction, thereby providing an indication of how other end users have provided feedback as an augmented information source for generating ingestion content recommendations.

At step 312, a topical model is run on the associated questions to match the associated interactions to a topical hierarchy. The processing at step 312 may be performed at the ingestion content recommendation engine 13 or the QA system 100 or other NLP question answering system which may apply any desired topical model to the associated questions identified at step 310. As described herein, the topical model process at step 312 may use machine learning techniques to apply well-known topic extraction methods, such as Latent Dirichlet Allocation (LDA), to automatically match a selected interaction to one or more topics. In other embodiments, the association process at step 312 may apply other topic extraction methods, such as Latent Semantic Analytics (LSA) (a.k.a., Latent Semantic Indexing (LSI)), to perform a singular value decomposition (SVD) or similar dimensionality reduction technique to automatically match a selected interaction to one or more topics. As a result of the processing step 312, each question and answer interaction may be identified or viewed as a collection of one or more topics from a specified topical hierarchy.

At step 314, each topic is correlated with user context information extracted from the question and answer interactions. The processing at step 314 may be performed at the ingestion content recommendation engine 13 or the QA system 100 or other NLP question answering system which may find associations or correlations between each topic in a known topical hierarchy and the other factors, such as user context, user profile, a question priority value assigned to a specific question, etc. As a result of processing at steps 304-314, the interaction history is mined based on confidence of the answers, user comments, similar user comments, question context, question frequency, question priority, sentiment from user comments, extracted terms, etc.

At step 316, one or more content sources are searched for new content using the extracted context and profile data extracted from the interaction history as search criteria. The content search process at step 316 may be performed at the ingestion content recommendation engine 13 or the QA system 100 or other NLP question answering system which searches content sources (e.g., 14), such as by submitting a query to an enterprise content management (ECM) system, knowledge management system (KMS), or similar document repository. In addition or in the alternative, the content search process step 316 may crawl the intranet, Internet, document repository database(s), and/or one or more cloud-based document repositories to look for new content matching the search criteria. As described herein, the content search process may search the content sources by using search criteria generated from the processing steps 304-314, such as question frequency, correlations, trends, deviations of terms, etc. For example, if the user query is “How do I pay my energy bill?”, some of the search results would be marked as relating to “energy legislation,” when in reality the user would be interested in information on how to pay a monthly electric or gas bill. Based on the term “energy bill” which is correlated with terms from comments by other users, the content search process would also generate search results or documents marked as relating to “energy bill payments.” As another example, the extracted user context information might identify “Austin” as the geo-location for the user inquiry, in which case the content search process would identify search results of documents to be ingested from utility providers from the identified geo-location, such as “Austin Energy,” and not the other utilities. As a result of using the extracted context and profile data extracted from the interaction history as search criteria in the search step 316, the retrieved new content will be filtered based on extracted user context information, such as user preferences, profile, priority, frequency, topical model, and context from interaction history.

At step 318, the ingested corpus (e.g., knowledge base 106) may be searched to see if the ingested corpus contains any documents that were retrieved from document repositories during the content search step 316. The search of the ingested corpus at step 318 may be performed at the ingestion content recommendation engine 13 or the QA system 100 or other NLP question answering system by submitting a query to the knowledge base 106 to look for ingested content matching the new content retrieved from the content sources at step 316. As a result of the processing step 318, efficiency in the overall process 303 is promoted by eliminating duplication of the subsequent document ingestion.

At step 320, the new content search results from step 316 are compared, differentiated, and merged with the existing ingested document results from step 318 before being added to an ingestion content recommendation list. The processing at step 320 may be performed at the ingestion content recommendation engine 13 or the QA system 100 or other NLP question answering system which performs a final comparison analysis and merging of new content and ingested content into a content recommendation list. For example, the generated recommendation list may include an actionable list of new documents that will be offered as recommendations for ingestion to the QA system 100. In selected embodiments, the content recommendation list may include a document link for the recommended new content and/or document meta information for the new content, along with a statement of the reason for including the content in the recommendation, such as the question(s) being addressed by the new content, the associated confidence, user comments, etc. As a result of the processing step 320, the ingestion content recommendation process 303 leverages a multifactorial topical model that is applied to the interaction history and context under which questions were posed to generate an actionable list of new content that is recommended for ingestion into the knowledge base corpus.

At step 322, a content recommendation list is presented to a domain expert for review, evaluation, and selection of content to be ingested in the knowledge database corpus (e.g., 106). The processing at step 412 may be performed at the ingestion content recommendation engine 13 or the QA system 100 or other NLP question answering system which displays the content recommendation list on a display (e.g., 15). In selected embodiments, the content recommendation list can be presented at step 322 in a web application or a mobile application which enables the domain expert or the system administrator to review the content recommendation list, select the entire set or a subset of the documents for ingestion, and/or choose to ignore one or more recommendations. As a result of a recommendation being selected at step 322, the selected new content will be automatically crawled and fetched from the content sources or document repositories, and provided or uploaded to the QA system 100 or other NLP question answering system for ingestion.

After using the ingestion content recommendation process 303 to mine the interaction history and extracted contextual information to present a dynamic content recommendation list of actionable insights for possible ingestion, the process ends at step 323, at which point the ingestion content recommendation process 303 may await reactivation by the domain expert or according to a predetermined or periodic activation schedule.

By now, it will be appreciated that there is disclosed herein a system, method, apparatus, and computer program product for generating actionable content ingestion recommendations at an information handling system having a processor and a memory. As disclosed, the system, method, apparatus, and computer program product mine an interaction history which stores a plurality of questions and answer results for a plurality of users, thereby extracting interaction context parameters for at least a first answer that meets specified answer deficiency criteria. Examples of the first answer meeting the specified answer deficiency criteria include if the first answer has a confidence measure below a minimum confidence threshold, if the first answer provides no response, if the first answer has an associated negative sentiment, if there are repeated questions relating to the first answer, or if the first answer has no supporting evidence. In selected embodiments, an information handling system capable of answering questions stores the plurality of questions and answer results in the interaction history. In selected embodiments, the interaction history is mined by performing a natural language processing (NLP) analysis of each question and answer in the interaction history, where the NLP analysis at least extracts key terms, question sentiment, question focus, N-grams, and lexical answer type information, from a first question corresponding to the first answer. In other embodiments, the interaction history is mined by performing NLP analysis of each question and answer in the interaction history to extract one or more profile parameters for each user that submitted a question stored in the interaction history, such as a first user location and time information for when a question was submitted by said user. In other embodiments, the interaction history is mined by performing an association analysis of each question and answer in the interaction history to identify one or more questions and associated comments that are similar to a first question corresponding to the first answer, such as by applying a collaborative filtering or market-based analysis to make automatic associations between questions from different users when identifying the one or more questions and associated comments. In other embodiments, the interaction history is mined by filtering the extracted interaction context parameters using a multifactorial topical model, such as a Latent Dirichlet Allocation (LDA) or Latent Semantic Analysis (LSA) model. Using the extracted interaction context parameters along with multi-factorial variable or attributes about the users, one or more content sources are searched to identify new content that is relevant to improving the first answer or adding new answers to a candidate answer list. In selected embodiments, the content source(s) search uses the extracted interaction context parameters to search against a document repository, enterprise content management (ECM) system, knowledge management system (KMS), or cloud-based document repository. In an actionable content ingestion recommendation that is displayed and reviewed by a domain expert, there is listed new content that is presented and recommended for ingestion in a knowledge base corpus. Using the actionable content ingestion recommendation, the domain expert may select the new content for ingestion in the knowledge base corpus.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of generating actionable content ingestion recommendations, the method comprising:
mining, by an information handling system comprising a processor and a memory, an interaction history comprising a plurality of questions and answer results for a plurality of users to extract interaction context parameters for at least a first answer that meets specified answer deficiency criteria;
searching, by the information handling system, one or more content sources using the extracted interaction context parameters along with multi-factorial variable or attributes about the users to identify new content that is relevant to improving the first answer or adding new answers to a candidate answer list; and
presenting, by the information handling system, an actionable content ingestion recommendation for display and review by a domain expert, where the actionable content ingestion recommendation lists the new content for ingestion in a knowledge base corpus.

2. The method of claim 1, further comprising storing, by an information handling system capable of answering questions, the plurality of questions and answer results in the interaction history.

3. The method of claim 1, where mining the interaction history comprises performing, by the information handling system, a natural language processing (NLP) analysis of each question and answer in the interaction history to at least extract key terms, question sentiment, question focus, N-grams, and lexical answer type information, from a first question corresponding to the first answer.

4. The method of claim 1, where mining the interaction history comprises performing, by the information handling system, a natural language processing (NLP) analysis of each question and answer in the interaction history, wherein the NLP analysis extracts one or more profile parameters for each user that submitted a question stored in the interaction history.

5. The method of claim 4, where the one or more profile parameters for each user comprise a first user location and time information for when a question was submitted by said user.

6. The method of claim 1, where mining the interaction history comprises performing, by the information handling system, an association analysis of each question and answer in the interaction history to identify one or more questions and associated comments that are similar to a first question corresponding to the first answer.

7. The method of claim 6, where performing an association analysis comprises applying, by the information handling system, a collaborative filtering or market-based analysis to make automatic associations between questions from different users when identifying the one or more questions and associated comments.

8. The method of claim 1, where mining the interaction history comprises filtering, by the information handling system, the extracted interaction context parameters using a multifactorial topical model, such as a Latent Dirichlet Allocation (LDA) or Latent Semantic Analysis (LSA) model.

9. The method of claim 1, where searching one or more content sources comprises using the extracted interaction context parameters to search against a document repository, enterprise content management (ECM) system, knowledge management system (KMS), or cloud-based document repository.

10. The method of claim 1, where the first answer meets the specified answer deficiency criteria if the first answer has a confidence measure below a minimum confidence threshold, if the first answer provides no response, if the first answer has an associated negative sentiment, if there are repeated questions relating to the first answer, or if the first answer has no supporting evidence.

11. The method of claim 1, further comprising selecting, by the domain expert, the new content for ingestion in the knowledge base corpus.

12-21. (canceled)
